(19) United States
(12) Patent Application Publication
(10) Pub. No.: US 2004/0252688 A1
(43) Pub. Date: Dec. 16, 2004

(54) Routing packets in frame-based data communication networks

(76) Inventors: George Anthony May, Sooke (CA); Abdu Omran, Victoria (CA); Dale John Shpak, Victoria (CA); Pei-Chong Tang, Victoria (CA)

Correspondence Address: BARNES & THORNBURG, 11 SOUTH MERIDIAN, INDIANAPOLIS, IN, 46204

(21) Appl. No.: 10/487,552

(22) PCT Filed: Aug. 28, 2001
(86) PCT No.: PCT/US01/26004

(51) Int. Cl. H04L 12/28

(52) U.S. Cl. 370/389

(57) ABSTRACT

Methods and apparatus (4.1-4.4) for the efficient transport and routing of packets over frame-based networks are disclosed. Groups of packets are encapsulated inside of frames (4.7, 4.8) and the frames (4.7, 4.8) are transported over a multiple-access network. Each frame (4.7, 4.8) contains one or more destination addresses. Unicast, multicast, and broadcast are supported.

### FIELD OF THE INVENTION

This invention relates to telecommunication network systems. It is disclosed in the context of a system for efficiently routing higher-layer protocols over frame-based networks, including the transport of Internet Protocol (hereinafter sometimes IP) packets over Synchronous Optical NETwork (hereinafter sometimes SONET) or Synchronous Digital Hierarchy (hereinafter sometimes SDH) transport. However, it is believed to be useful in other applications as well.

### BACKGROUND OF THE INVENTION

The demand for bandwidth in data communication networks is doubling every six months. It is unlikely that this growth in demand will diminish in the immediate future. Indeed, there are reasonably reliable predictions that it may accelerate. As Voice over Internet Protocol (hereinafter sometimes VoIP), storage over IP, streaming multimedia, Internet appliances and wireless 3G networks proliferate, the demand for bandwidth will only increase.

Telecommunication service providers are faced with two significant obstacles to this explosive growth. First, existing, or legacy, telecom networks were not designed to transport packet-based data efficiently, and certainly were not designed to scale up in data-handling capacity at the rate that packet-based data traffic is increasing. Second, most existing telecoms' primary revenue streams are based on voice data, while their fastest-rising and most significant demands and costs are those associated with the increase of packet-based data traffic. Thus, the telecoms are faced with a dilemma. They can either invest significant amounts of capital to build high-capacity data networks or risk obsolescence.

Data is generally switched two ways. Voice, for example, has historically been circuit switched. In a circuit switched network each data stream is sent over a circuit between the sender and the receiver. This circuit is dedicated for exclusive use for the duration of the data transmission. Although circuit switching is convenient for voice data such as telephone calls, it is very inefficient for other types of data communications. Digital data, such as a file being downloaded, is generally packet switched. That is, a data file is segmented into multiple packets. The individual packets are then sent along whatever path(s) is (are) available to their destination where they are reassembled into the transmitted file.

Historically, telecoms only had to transport voice traffic. Data traffic came along much later, and input/output devices were developed to interface data sources with telecoms' legacy networks. By the mid-to-late eighties, telecoms had developed the practice of maintaining distinct parallel networks for voice and data. The voice networks remained circuit switched. The data networks were packet switched. In the early nineties, the first efforts began to converge network switching to the packet switching model.

In the early nineties, telecommunication engineers began developing mechanisms for connecting the separate voice and data networks to a common SONET ring. SONET (as well as SDH, the standard widely used outside of North America) permitted multiple services based on Time Division Multiple Access (hereinafter sometimes TDMA) to be multiplexed from lower-speed, for example, voice, circuits into layers in the SONET hierarchy. The tremendous bandwidth available over the common SONET/SDH interface made it attractive to carry IP traffic over a frame relay and/or an Asynchronous Transfer Mode (hereinafter sometimes ATM) backbone network. As the volume of IP traffic increases, it becomes more desirable to carry IP traffic directly over SONET, at least in the network backbone where demand is high and increasing.

Currently, the focus of IP transport continues to be data-oriented. However, a significant trend in the industry is the emerging demand for the support of real-time IP services, such as IP telephony. With the increasing demand for such services, there is an attendant need to develop SONET/SDH data routers with sophisticated Quality of Services (hereinafter sometimes QoS) mechanisms.

By the mid nineties, telecommunication engineers routinely encountered the need to efficiently transport and route large amounts of packet-formatted data, namely IP data, originating from Local Area Networks (hereinafter sometimes LANs). A solution they developed was to locate ATM networks as intermediate transport layers between the LANs and backbone SONET rings. In the short term, ATM was a good solution. ATM provided extensive bandwidth management, wire speed switching, network based addressing, routing, and QoS control over the network. ATM also provided for the convergence of circuit-switched data (such as voice) and packet-switched data (such as IP-based file transfers) onto a single transport system.

However, using an ATM layer was not a perfect solution. An ATM network is a cell-based network, and the Public Switched Telephone Network (hereinafter sometimes PSTN) is Time Division Multiplexed (hereinafter sometimes TDM). Telecommunication engineers used ATM networks in the beginning to transport circuit-switched data such as T1, Digital Subscriber (at 1.544 Mb/s), and DS-3 (45 Mb/s). The overhead resulting from ATM headers and data packetization resulted in inefficiency in bandwidth utilization. Additionally there is some time delay associated with ATM because ATM is connection oriented and a connection takes a finite time to set up. Further, to transport circuit-switched data over an ATM network requires equipment called a Circuit Emulation Switch (hereinafter sometimes CES) to convert the TDM traffic to ATM cells for transport. Then, as the traffic arrives at its destination it must be converted back to TDM. This added functionality and control is expensive both in terms of the overhead bandwidth and the capital cost of adding another network layer.

By the late nineties, IP had evolved to the point where it incorporated much of the network management functionality of ATM. Now it was possible to transport IP packets over SONET without requiring an intermediate ATM layer. However, the Packet Over SONET (hereinafter sometimes POS) protocol that was developed for this purpose requires the IP data to undergo an encapsulation process. This multi-level encapsulation process starts by encapsulating the IP packet in a Point-to-Point Protocol (hereinafter sometimes PPP) frame. This PPP frame is then framed using a High-Level Data Link Control (hereinafter sometimes HDLC)-like framing for packet delineation and error control. These frames are then transported inside of SONET frames. Although these HDLC frames are sent inside of SONET frames, the POS frames are sent as a byte-oriented stream using a point-to-point link to the next node. They do not make use of the framing information that is provided by the SONET overhead bytes. And, because PPP is used, the packet must pass through every node in the network and be regenerated at each node for transit to the next node. This process includes a costly segmentation and reassembly of the packet. In some cases the POS protocol was then transported over ATM, resulting in further inefficiencies resulting in 40 to 45% of the system bandwidth being used for overhead.

With existing POS systems, PPP is used with the SONET ring because SONET was originally designed as a point-to-point network. In these systems, the packet must pass through every node in the network and be regenerated at each node for transit to the next node. Also, PPP alone is not sufficient for true data encapsulation. It can be used for mapping and translation only if the X.25 HDLC protocol and a mechanism called Address Resolution Protocol (hereinafter sometimes ARP) are employed to translate and map each data packet to its destination through the point-to-point SONET network. However, this requires stripping out the HDLC frame at each node, analyzing the header and then re-packaging it for the next PPP link.

SONET was originally designed to be a simple transport system for TDM voice signals that could be used at high line rates using, by modern standards, relatively simple electronics. Because of this, SONET protocols are less well suited as data transport protocols than protocols specifically designed for data transmission, such as IP or ATM. SONET engineers have focused on increasing line rates and improving administration tools rather than improving the intrinsic data transport performance of SONET. To date, data transport over SONET has been accomplished by adding protocol layers above the SONET transport layer.

With many of the existing routing and data transfer protocols approaching their speed and bandwidth limits, some network engineers have turned their attention to increasing the raw bandwidth of SONET rings. Many solutions have developed around large channel-count Dense Wavelength Division Multiplexing (hereinafter sometimes DWDM) and running the rings at very high speeds, up to Optical Carrier (hereinafter sometimes OC)-768. These “brute force” solutions of simply making available the capacity to transmit photons at a greater number of discrete frequencies around the ring are capital intensive and complex. Every time a wavelength is split, for example, at a node in a DWDM network, the signal strength is divided. Thus, the optoelectronics must be able to process increasingly fainter signals. When the whole system is run at very high speeds, the problems are compounded. Indeed, many speculate that OC-768 optoelectronics can only be made from esoteric compound semiconductors such as InP.

The present invention proposes an alternative to this brute force approach, namely to identify and remedy inefficiencies, thereby improving the utilization of the existing SONET infrastructure.

Another important aspect of modern data communications is the increasing importance of reliability and latency. Telephone services require a very high level of availability and low latency. The normal standard of operation is the so-called “five nines” standard of reliability. That is, the system must be available 99.999% of the time. This corresponds to an acceptable outage of five minutes per year. Although this provides an excellent level of service, the emerging standard is “six nines.” That is, the system must be available 99.9999% of the time. Many existing IP network technologies (such as Ethernet LANs) do not have high levels of reliability and predictable latency because they were not developed for voice transport. At the same time, as the Internet evolves and an increasing amount of loss-sensitive and time-critical information is transported using IP packets, there is a corresponding increase in demand for reliable transport of IP traffic. This is one of the reasons why SONET remains an attractive technology for the transport of IP traffic.

One of the reasons for SONET's reliability is that, in most installations, data circulates in opposite directions around dual optical fiber rings to provide redundant connectivity between the nodes. FIG. 1 illustrates a typical SONET Bidirectional Line Switched Ring (hereinafter sometimes BLSR) in which data frames 1.5 and 1.6 flow in opposite directions in the two rings 1.7 and 1.8, sometimes referred to herein as an inner ring and an outer ring. Under normal operation, each ring carries traffic that is one-half or less of its total capacity. In the event of the failure of a segment of one of the rings, each node that is adjacent to the failure will wrap traffic between the inner and outer rings. This permits the network to continue to operate in the event of disruption of the working ring or network equipment such as an Add/Drop Multiplexer (hereinafter sometimes ADM) 1.1-1.4 at any location along the working ring. SONET systems have Automatic Protection Switching (hereinafter sometimes APS) to detect signal failures and switch traffic between the inner and outer rings to isolate and direct traffic around the fault. If the SONET system is being used to transport IP traffic, the ADMs typically will be connected to IP routers 1.9, 1.11, 1.13.

As noted above, SONET uses TDM to multiplex and demultiplex low-speed data traffic to or from a high-speed optical transport network. Each such low-speed connection is semi-permanently allocated a fraction of the capacity of the high-speed ring by “provisioning” bandwidth. This provisioning assigns bandwidth from each node to each other node. This provisioning can be thought of as a multi-lane highway in which a lane is allocated for traffic from one ADM to another ADM. Since SONET is a TDM system, the lanes are provisioned by allocating time slots in the TDM sequence. With provisioning, the communication between each pair of ADMs is point-to-point. That is, if a specific set of time slots are provisioned for sending traffic 1.6 from ADM 1.4 to ADM 1.1 along a ring illustrated in FIG. 1, that provisioned capacity is not used for any other purpose by the equipment on the ring. ADMs not using a particular lane simply forward traffic not addressed to them, without inspecting or otherwise processing it.

SONET was designed to be a reliable circuit-switched network. SONET owes its reliability in part to the 100% capacity redundancy. As noted above, SONET provides two fiberoptic rings. Each ring normally carries 50% or less of its rated capacity. However, when SONET is being used to transport bursty, packet-based traffic such as IP, the 100% redundancy requirement results in considerable excess capacity. For IP traffic, it is more effective to require 100% redundancy only for traffic that requires relatively high availability under the terms of a service-level agreement (hereinafter sometimes SLA) between the carrier and the customer. Traffic that does not require such availability can be transported using capacity that is not supported by redundancy. In the event of a ring failure, low priority traffic is reduced so that traffic requiring high availability can be transported in accordance with the terms of outstanding SLAs.

One method for the transport of IP traffic that can be used with SONET is Dynamic Packet Transport (hereinafter sometimes DPT) which uses Spatial Reuse Protocol (hereinafter sometimes SRP). SRP does not use point-to-point links in the traditional sense. With SRP, IP packets are transported inside of SRP packets and the SRP data is sent as a byte-oriented stream that does not utilize the SONET framing mechanisms. Referring to FIG. 2, each IP packet 2.1-2.4 is encapsulated and has its own SRP header 2.5-2.8. The SRP headers contain information that is used as an addressable link-layer protocol.

At each SRP node, the destination address for every SRP packet is inspected to determine if the destination is the current node. If it is, the SRP packet is stripped from the data stream and processed by the current node. If the destination is not the current node, the current node performs a table lookup to determine which optical interface is the destination for that SRP packet. Because SRP utilizes both rings concurrently, it supports two sets of optical interfaces per node.

SRP requires a plurality of packet buffers for its operation. Essentially, traffic from the current node is sent to an output optical interface whenever there is available capacity in the optical transport system. The detailed decisions regarding which packets are sent to the output depend on the priority and the source of the traffic. Packets remain buffered until they are sent. A global fairness algorithm provides each node fair access to the capacity of the ring.

SRP does not observe the SONET paradigm of having 100% capacity redundancy between the inner and outer rings. Instead, all of the capacity in both rings is available for transport. SRP has its own protection mechanism. It does not use SONET's protection switching. If a protection switching event, such as a break in one of the rings, occurs, the network capacity in the vicinity of the event is reduced. This, of course, affects the total capacity of the optical network.

### DISCLOSURE OF THE INVENTION

According to one aspect of the invention, a method and apparatus are provided for transporting data packets through a data transport network including multiple interconnected circuits. The method includes aggregating data packets into frames, each frame including a first field which indicates the destination address of the frame. The apparatus includes a first device for aggregating data packets into frames, each frame including a first field which indicates the destination address of the frame.

Illustratively according to this aspect of the invention, the method further includes inspecting the first field when the frame is received at a node, and, if the first field contains an address served by the node, extracting the packets destined for the address served by the node, and forwarding to the next node frames not destined for addresses served by the node. The apparatus further includes a second device for inspecting the first field when the frame is received at a node, extracting the packets destined for the address served by the node if the first field contains an address served by the node, and forwarding to the next node frames not destined for addresses served by the node.

Further illustratively according to this aspect of the invention, aggregating data packets into frames includes aggregating data packets into frames, each containing a second field which indicates frame delivery requirements. The first device aggregates data packets into frames, each containing a second field which indicates frame delivery requirements.

Additionally illustratively according to this aspect of the invention, aggregating data packets into frames, each containing a second field which indicates frame delivery requirements includes aggregating data packets into frames, each containing a second field which indicates a priority for queueing of frames for transport. The first device aggregates data packets into frames, each containing a second field which indicates a priority for queueing of frames for transport.

Illustratively according to this aspect of the invention, the method further includes using the content of the second field to verify a packet transport level of service agreement between a network proprietor and a subscriber to that level of service. The first device uses the content of the second field to verify a packet transport level of service agreement between a network proprietor and a subscriber to that level of service.

According to another aspect of the invention, a method and apparatus are provided for transporting data packets through a data transport network including multiple interconnected circuits. The method includes aggregating data packets into frames, each frame including a field which indicates to a node on the network whether the node is to forward a packet without first inspecting it. The apparatus includes a first device for aggregating data packets into frames, each frame including a field which indicates to a node on the network whether the node is to forward a packet without first inspecting it.

According to another aspect of the invention, a method and apparatus are provided for transporting data packets through a data transport network including multiple interconnected circuits. The method includes aggregating data packets into frames, at least one frame including a fragment containing less than all of the packet addressed to a destination address. The apparatus includes a device for aggregating data packets into frames, at least one frame including a fragment containing less than all of the packet addressed to a destination address.

According to another aspect of the invention, a method and apparatus are provided for multicasting data packets in a data transport network including multiple interconnected circuits. The method includes providing the data packets to be multicast with the destination addresses which are to receive the multicast data packets. The apparatus includes a first device for aggregating the data packets to be multicast with destination addresses which are to receive the multicast data packets.

Illustratively according to this aspect of the invention, providing the data packets to be multicast with the destination addresses which are to receive the multicast data packets includes providing the data packets with multiple headers, each of the multiple headers having one of the destination addresses. The first device includes a first device for providing the data packets with multiple headers. Each of the multiple headers has one of the destination addresses.

Further illustratively according to this aspect of the invention, the method includes aggregating the data packets into frames, and providing the data packets with multiple headers, each having one of the destination addresses. Each of the multiple headers is provided with a field which contains a value which indicates the distance from a boundary within the frame to the data associated with that header. The first device provides in each of the multiple headers a field which contains a value which indicates the distance from a boundary within the frame to the data associated with that header.

According to another aspect of the invention, a method and apparatus are provided for transporting data packets through a frame-based data transport network including multiple interconnected circuits. The method includes aggregating data packets into frames, providing a device for identifying frames containing packets destined for addresses served by the device, and routing the identified packets to the addresses served by the device. The apparatus includes a device for identifying frames containing packets destined for addresses served by the device and routing the identified packets to the addresses served by the device.

According to another aspect of the invention, a method and apparatus are provided for transporting data packets through a data transport network including multiple interconnected circuits. The method includes aggregating data packets into frames, at least some of the frames being partitioned into subframes. The apparatus includes a first device for aggregating data packets into frames, at least some of the frames being partitioned into subframes. Each subframe contains one or more destination addresses and packet data intended for those one or more destination addresses.

### BRIEF DESCRIPTION OF THE DRAWINGS

The invention may best be understood by referring to the following detailed description and accompanying drawings which illustrate the invention. In the drawings:

FIG. 1 is a schematic illustration of a SONET bidirectional line-switched ring (hereinafter sometimes BLSR) network;

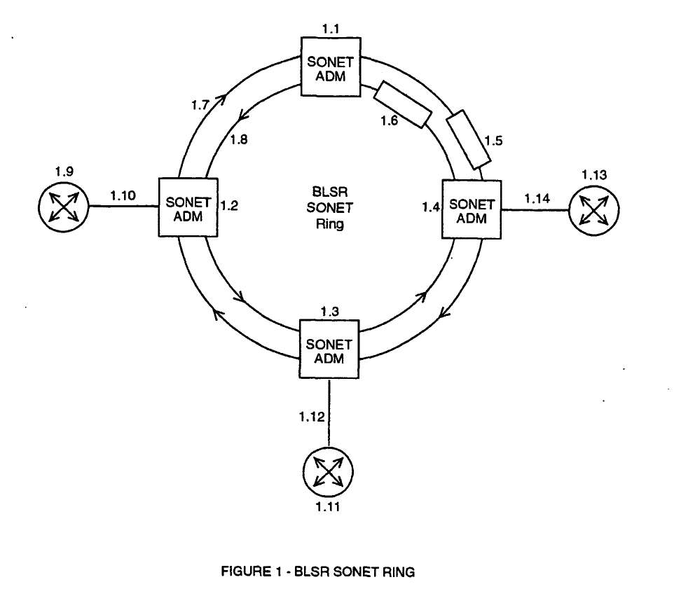

FIG. 2 illustrates the transport of IP packets using SRP and SONET;

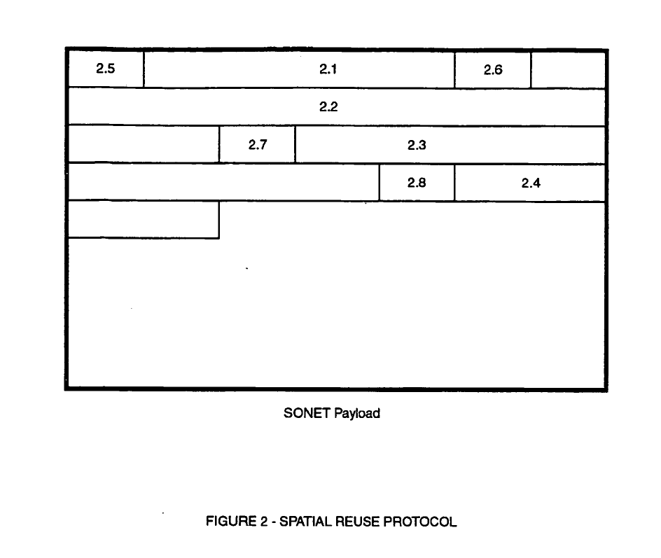

FIG. 3 illustrates the contents of a SONET Synchronous Transport Signal level 1 (hereinafter sometimes STS-1) frame;

FIG. 4 illustrates the flow of traffic in a four-node SONET BLSR network;

FIG. 5 illustrates the contents of a SONET STS-1 frame having a single ERP header;

FIG. 6 illustrates the contents of the ERP header;

FIG. 7 is a conceptual block diagram which illustrates data handling by a typical ERP-capable node;

FIG. 8 illustrates a flow diagram of a process for constructing a frame that supports payload aggregation and header concatenation;

FIG. 9 illustrates a frame using header concatenation with multiple ERP headers and packets destined for multiple nodes; and

FIG. 10 illustrates a schematic diagram of an embodiment of the invention.

### DETAILED DESCRIPTIONS OF ILLUSTRATIVE EMBODIMENTS

The term frame, as used herein, means a fixed-length logical unit of data that is typically arranged as a binary sequence having a specified number of octets of data. The term packet, as used herein, refers to a fixed- or variable-length sequence of data having a header containing control information such as a destination address. The term destination, as used herein, generally means either a final destination or the terminal end of a next hop. The term ring, as used herein, generally means the frame-based network whether it is a ring, mesh, linear, or other topology. When the path through the network's topology does not have a closed loop, frames that in a closed loop would be dropped by the originating node are dropped by the node at the termination of the path.

This invention relates to methods and apparatus by which a routeable protocol, such as IP, can be efficiently transported and routed using a frame-based transport network, such as SONET or SDH. The methods and apparatus include a protocol and methods for efficiently aggregating and transporting routeable packets that are located within the payload portion of frames. The methods and apparatus are disclosed in the context of the SONET protocol, but are believed to be useful in other applications as well.

Methods and apparatus are provided by which routeable packets can be efficiently transported and routed within a frame-based network. Packets having a common next hop or destination are mapped into source-routed frames. The methods and apparatus also support multicast and have features to support traffic engineering for guaranteeing QoS.

Because they are SONET-compliant, the methods and apparatus can be used transparently on existing SONET networks. The Encapsulation Routing Protocol (hereinafter sometimes ERP) described herein is not directly compatible with existing packet transport methods. However, an ERP-capable node can emulate less efficient legacy methods to operate with equipment using existing IP transport mechanisms such as POS or IP over ATM (IPOATM). The methods and apparatus provide efficient packet transport using ERP.

The methods and apparatus are unlike prior art methods and apparatus for transporting IP packets over SONET in that they do not use PPP, HDLC, or ATM. However, they do use the SONET framing mechanism. And, although nodes incorporating the present methods and apparatus can operate via conventional point-to-point connections, the present methods and apparatus permit multiple nodes to share the capacity of one or more provisioned (or unprovisioned) optical links.

The present methods and apparatus comply with SONET standards. At the transport level, the present methods and apparatus are compatible with existing SONET-compliant network equipment. Thus, rather than requiring the expensive upgrading or replacement of existing equipment, the present methods and apparatus can operate transparently on rings containing legacy equipment. This is unlike other proposed improvements to SONET, such as Cisco Systems' DPT, or “SONET-lite,” as it is sometimes called, that use a SONET-like transport system, but break compatibility with existing SONET equipment.

SONET has been adapted for the transport of other forms of data traffic such as ATM cells and IP packets. A primary reference document for SONET is Bellcore GR-253 “Synchronous Optical Network Transport System,” which is incorporated herein by reference. SONET multiplexing equipment, such as ADMs, send frames of data to each other over provisioned TDM channels. SONET was originally designed for the transport of digitized telephone conversations at a frame rate of 8 kHz. Since the frame rate is fixed, higher data rates are accommodated by sending larger frames. In the SONET standards, the resulting data rates are integral multiples of 51.84 Mbps, which is referred to as STS-1. These data rates include

| | | |
|---|---|---|
| STS-1 | | 51.84 |
| STS-3 | OC-3 | 155.52 |
| STS-12 | OC-12 | 622.08 |
| STS-48 | OC-48 | 2,488.32 |
| STS-192 | OC-192 | 9,953.28 |

wherein the OC designations are used in the context of data transport over optical links. An OC-12 ring can transport twelve STS-1 tributaries.

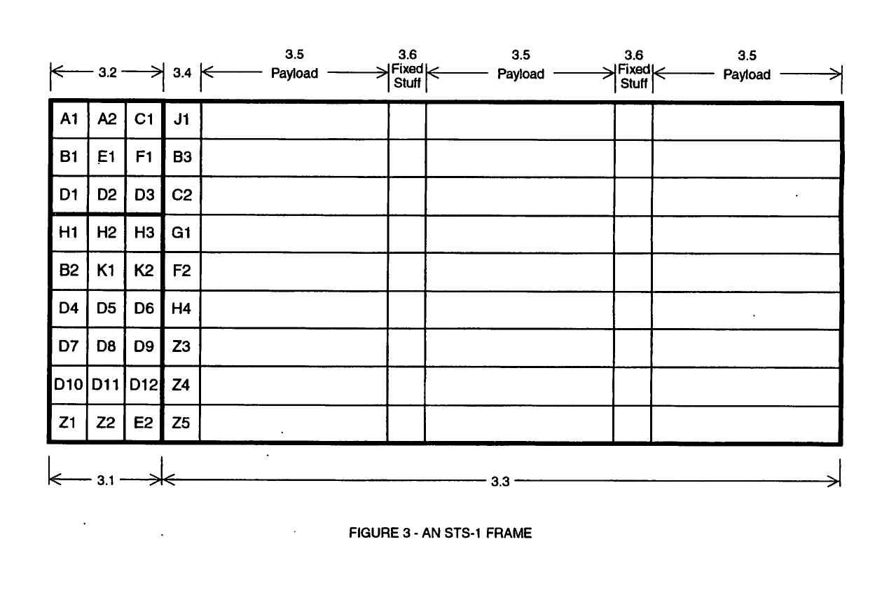

Referring now to FIG. 3, each STS-1 SONET frame includes bytes for line overhead 3.1, bytes for section overhead 3.2, and bytes within the synchronous payload envelope (SPE) 3.3. The SPE 3.3 contains bytes for path overhead 3.4, bytes for payload 3.5, and fixed stuff 3.6. As illustrated above, multiple STS-1 tributaries can be transported over a higher-speed link. For example, an STS-3 frame contains three STS-1 tributaries which are byte-interleaved inside of the STS-3 frame. Each SONET frame is arranged as nine rows and N columns. The frame data is transmitted over a serial optical link starting with the first byte in the first row, and proceeding row-wise until the entire frame has been transmitted.

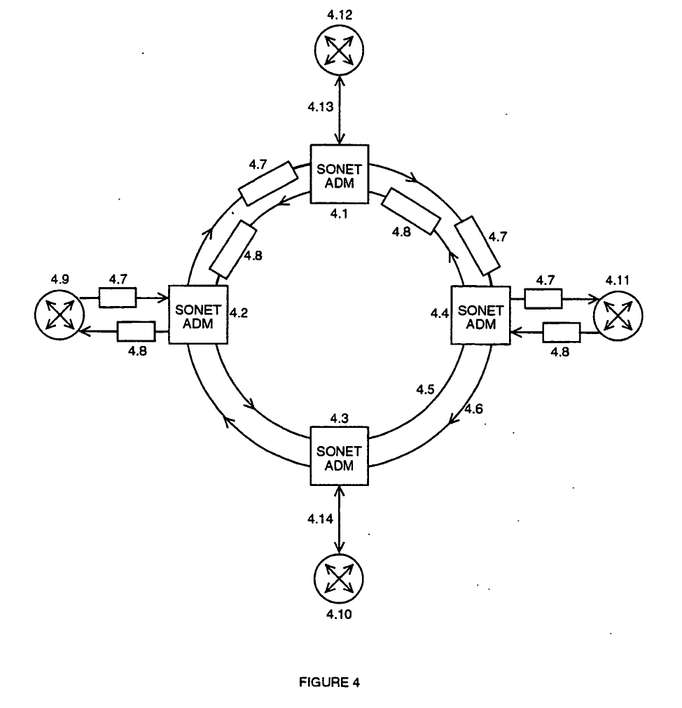

In a typical SONET system illustrated in FIG. 4, a number of nodes 4.1-4.4 (illustrated as ADMs) are interconnected using two rings of optical fiber 4.5-4.6. Data frames 4.8 in one ring 4.5 are transported in a first direction, sometimes referred to hereinafter as counter-clockwise. Data frames 4.7 in the other ring 4.6 are transported in a second and opposite direction, sometimes referred to hereinafter as clockwise.

When a SONET system is used for data transport, such as IP packets, the ADMs 4.1-4.4 are typically connected with other network equipment 4.9-4.12 such as ATM switches or routers, which then forward the IP packets to other connected networks, such as Ethernet or ATM networks.

The transport capacity between nodes 4.1-4.4 is provisioned by programming each node 4.1-4.4 to send or receive its data using specified STS-1 tributaries within the SPE 3.3. Any STS-1 tributary that is not used by that node 4.1-4.4 for sending or receiving data is forwarded unmodified to the next node 4.1-4.4 along the ring. In an OC-12 ring, for example, if two STS-1 tributaries are provisioned for sending data from node 4.4 to node 4.2, then node 4.1 will forward those STS-1 tributaries without inspecting or modifying them.

As an example of SONET operation, consider sending data over an OC-12 ring between nodes 4.4 and 4.2 using the first and second STS-1 tributaries. Frames 4.8 of data depart from the node 4.4 on fiber-optic ring 4.5 and arrive at node 4.1. Node 4.1 forwards these two tributaries unmodified (although it may act upon other STS-1 tributaries).

The methods and apparatus of this invention can operate on networks that use provisioning, as well as on networks that do not use provisioning. The support for provisioning permits nodes having reduced complexity, since tributaries that are simply forwarded require less processing than tributaries that the node must process. And, like SRP, ERP can concurrently use both rings. Additionally, the ERP can be extended to more than two rings.

Unlike existing encapsulation methods such as PPP, ERP does not require a point-to-point link. Instead, ERP uses addressable multiple-access methods that permit the entire frame 4.8 to be routed over a frame-based transport layer having multiple nodes sharing the same communication channel. Addressable multiple-access frame-based routing is believed to be unique to the disclosed methods and apparatus.

In an illustrated embodiment, IP packets are routed and mapped into SONET frames 4.8. The SONET transport network includes multiple nodes that are interconnected within rings or meshes. The rings and meshes can also be interconnected to form a wide-area network (hereinafter sometimes WAN) for packet transport. The network topology can include multiple paths between destinations for greater availability. Routing over these multiple paths can use existing routing protocols.

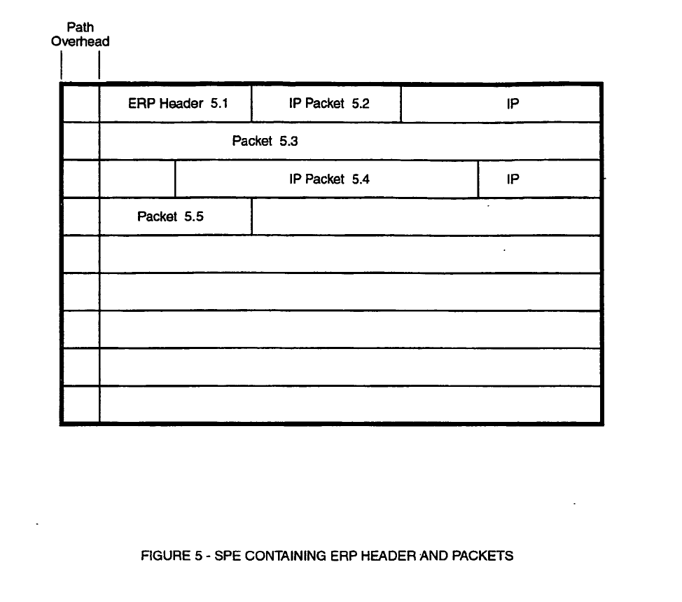

According to the methods and apparatus, IP packets are aggregated into frames 4.8. The size of a frame 4.8 is implementation-dependent. In an illustrative embodiment, the frame size is 774 octets which is the size of a SONET STS-1 frame, less the line, section, and path overhead. IP packets have variable lengths of up to 65536 octets, although Ethernet networks use a maximum transfer unit (MTU) of 1522 octets. The typical packets in an IP network are relatively small, on the order of 50 octets. As illustrated in the SPE of FIG. 5, several IP packets 5.2-5.5 can be transported in a single SPE.

Alternatively, a frame such as a SONET STS-1 frame can be divided into subframes. For example, the 774 octet payload can be divided into three 258 octet subframes. Each of these subframes can be treated as a separate ERP frame having a smaller capacity than the original frame 4.8. This can be used, for example, to control the granularity of the data transport system. That is, it further facilitates the transport of data packets addressed to multiple addresses in a common frame so that, for example, each of three consecutive subframes can contain 258 octets of data bound for one of three different addresses, rather than having a frame containing 774 octets of data bound for a first one of the three addresses, a later frame containing 774 octets of data bound for a second one of the addresses, and a still later frame containing 774 octets of data bound for a third one of the addresses. There is somewhat of an increase in transport overhead because of the multiple headers in the frame, but the use of subframes permits the network to be “tuned” to the traffic and latency demands of subscribers, or otherwise for optimum performance.

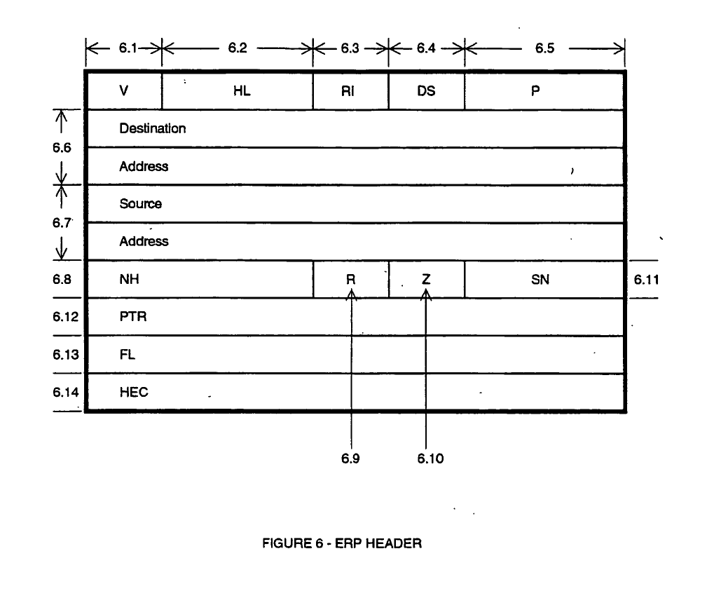

Each ERP frame 4.8 includes a header 5.1 that is used as a medium-access control (hereinafter sometimes MAC) layer protocol. The header in the illustrated embodiment includes 18 octets of information. The first field 6.1 in the header structure illustrated in FIG. 6 is the 2-bit version number, currently zero. This two-bit number is incremented (modulo 4) whenever a new version of the ERP header is released.

The second field 6.2 is the 8-bit hop limit (hereinafter sometimes HL) field. The node that originates the frame 4.8 uses a software-selectable parameter to set the initial value of the HL field 6.2. Each node that forwards this frame 4.8 decrements the HL field 6.2 by one. The frame 4.8 is discarded if the HL field 6.2 reaches zero. The purpose of the HL field 6.2 is to prevent frames 4.8 from continuously circulating around the ring if a frame 4.8 has a bad destination address, a node is malfunctioning, or if either of the destination or source nodes exit the network. For the same reason, on ring-based networks, any frames 4.8 that return to the originating node along the same ring along which the packet was sent are dropped.

The ring indicator bit 6.3 specifies the ring on which the packet was originally sent. It may be set to zero for the outer ring and to one for the inner ring, for example. The destination strip (hereinafter sometimes DS) bit 6.4 instructs the destination node whether or not to forward the packet.

The 4-bit priority (hereinafter sometimes P) field 6.5 is used to indicate the priority, latency requirements, and loss tolerance of the frame 4.8. The P field helps control frame transport queuing and, in the illustrated embodiment, has the same meaning as the IPv6 priority field in IP. The P field helps provide the QoS verification for each SLA.

The 32-bit destination address (hereinafter sometimes DA) 6.6 indicates the destination of the frame 4.8, a unique address of a specific interface on a particular node and the 32-bit source address (hereinafter sometimes SA) 6.7 indicates a specific interface on the source node. The use of these address fields is similar to that of the 48-bit MAC address in the IEEE 802 standard.

The 8-bit next header (hereinafter sometimes NH) field 6.8 indicates the type of header that immediately follows the ERP header. In the illustrated embodiment, if IPv4 packets follow the ERP header, NH is set to 01 (hexadecimal) whereas if another ERP header follows the ERP header, NH is set to 04 hex. This field can also provide a mechanism for header concatenation.

The read (hereinafter sometimes R) bit 6.9 is initially set to zero. It is set to one by the destination node to indicate that the destination node has read the frame 4.8. This is useful when determining the drop location(s) of frames containing concatenated headers.

The reserved (Z) bit 6.10 is unused in the illustrated embodiment.

The 6-bit sequence number field 6.11 is a modulo-64 counter that is used to ensure in-order processing of frames 4.8 by the receiving node. This aids the correct reassembly of packets that are fragmented across frame 4.8 boundaries.

The 16-bit offset pointer (hereinafter sometimes PTR) field 6.12 is the index in octets of the start of the data packets for the destination node specified by the DA 6.6 in the current header. It is measured from the start of the STS-1 payload area.

The 16-bit fragment length (hereinafter sometimes FL) field 6.13 indicates the length of the packet fragment, if any, for the first packet for this ERP header. If there is no packet fragment, this is set to zero.

The PTR and FL fields 6.12 and 6.13 simplify packet extraction in the illustrated embodiment. The PTR field permits the frame processor to locate the start of the packet data for this destination node more readily. The FL field aids in locating the packet that immediately follows the fragment.

The header error control field 6.14 is a 16-bit cyclic redundancy check (hereinafter sometimes CRC) that is computed over all of the other header bits. In the illustrated embodiment, the CRC generator polynomial is the ITU standard x¹⁵+x¹²+x⁵+1.

Referring now to FIG. 5, when filling a frame 4.8 with IP packets, it is unlikely that an integral number of packets will exactly fit the frame 4.8. When an integral number of IP packets do not exactly fit the frame 4.8, there are two options. The first option is that, if a packet would exceed the capacity of the current frame 4.8, that IP packet is not placed into the current frame 4.8, and the remainder of the current frame 4.8 is filled with stuff bytes. This excluded packet is then used to start filling the next frame. The second option is to fragment the packet, using part of its contents to fill the current frame 4.8 and putting the remaining packet contents into a subsequent frame. To transport large IP packets, such as, for example, a 1500 octet packet, larger than an STS-1 SPE, the second option must be supported.

Both of these frame-filling options are available in the illustrated embodiment. If the current frame 4.8 has only Q octets of capacity remaining, where Q is a software-configurable parameter, and the next packet selected for transport in this frame is larger than Q octets then the next packet will be used to begin filling a subsequent frame and the remainder of the current frame 4.8 will be filled with stuff bytes. If a packet is fragmented so that part of the packet is transported in a subsequent frame, the FL field 6.13 in the ERP header of this subsequent frame is set to the number of octets from the packet that are transported within the subsequent frame. The FL field 6.13 is used by the receiving node to simplify packet extraction from the frame 4.8.

For unicast packets, all of the packets within a particular ERP frame 4.8 often have the same node as their next destination along their path to their final destination. ERP also supports broadcast and multicast over the SONET network. Because ERP uses a MAC address on the frame-based network, broadcast and multicast can be handled in a manner similar to that used by Ethernet IP networks. For broadcast, the destination address 6.6 in the illustrated embodiment is set to all ones and the DS bit 6.4 is set to zero. This causes the frame 4.8 to circulate on the network and then be stripped by the source node.

Multicast packets can be handled using any of four different methods. The first method is to use a broadcast frame 4.8. In this case, the other nodes on the ring receive the frame 4.8 and forward the packets both to the node's router 7.5 and to the next node. The router 7.5 then either utilizes or drops the packets, depending on whether any network connected to the node requires the multicast data. The second method is for the source node to replicate the packets and forward separate copies of the packets to each node that has subscribed to the multicast. The third method is to reserve a subset of the destination address space for multicast, as is done with Internet Protocol. A node can subscribe to a particular multicast by receiving frames having that specific multicast address. To accomplish this, the node is capable of receiving frames with various selected destination addresses. A fourth method according to this invention is to use header concatenation, in which multiple ERP headers refer to the same packets. The multiple references to the same packets are achieved by using the same value for the PTR field 6.12 in the multiple headers. This has two advantages. First, the frames 4.8 are addressed only to the nodes that require them. They are not broadcasted. Therefore, unlike the processing of broadcast frames 4.8, only the multicast packets required by each router are forwarded to that router by the frame processor. Second, network bandwidth is not wasted by sending multiple copies of the same packets. This is in contrast to the replicate and forward method.

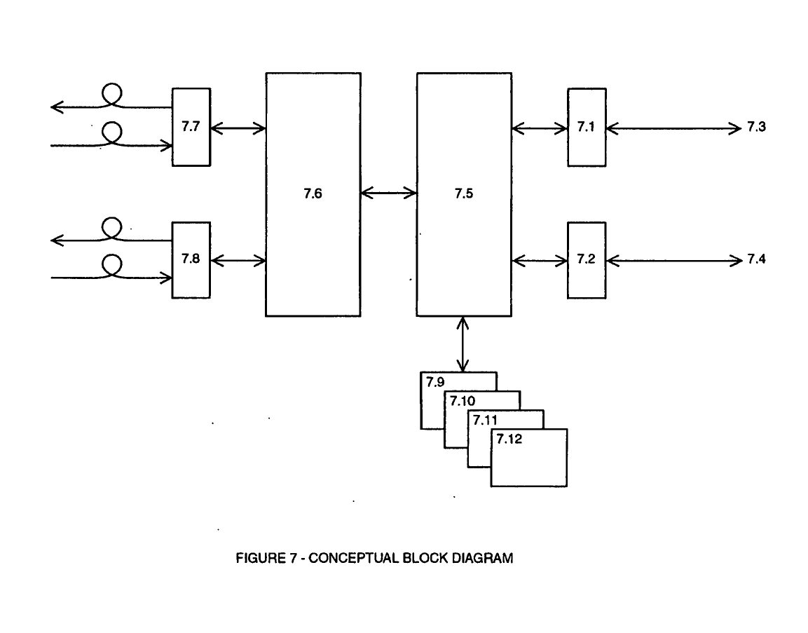

Referring now to FIG. 7, the operation of each node will be described. When a local interface 7.1 such as an Ethernet interface receives packets from a local network 7.3, these packets are processed by the router 7.5. If the node has a plurality of local interfaces, the next hop or destination for these packets will either be through another local interface 7.2 to some other local network 7.4 or through a node that is reachable through an interface 7.7 or 7.8 on the frame-based network.

If the destination is reachable through a local interface 7.2, the router will send the packet to that local interface, as in the prior art. If the destination is reachable through an interface 7.7-7.8 on the frame-based network, the packet is queued into a frame buffer 7.9-7.12 by the router.

The router maintains a plurality of frame buffers 7.9-7.12, normally at least one for every other node that is attached to the same frame-based network, that is, at least one buffer 7.9-7.12 for every node connected to the same SONET UPSR or BLSR. When multiple priority levels (refer to the above discussion of the P field 6.5) are used, there will normally be buffers for each supported individual priority level or group of priority levels. Each frame buffer 7.9-7.12 has a destination address 6.6 that corresponds to the destination node. As packets arrive from the local interfaces 7.1, 7.2, these packets fill the frame buffers 7.9-7.12.

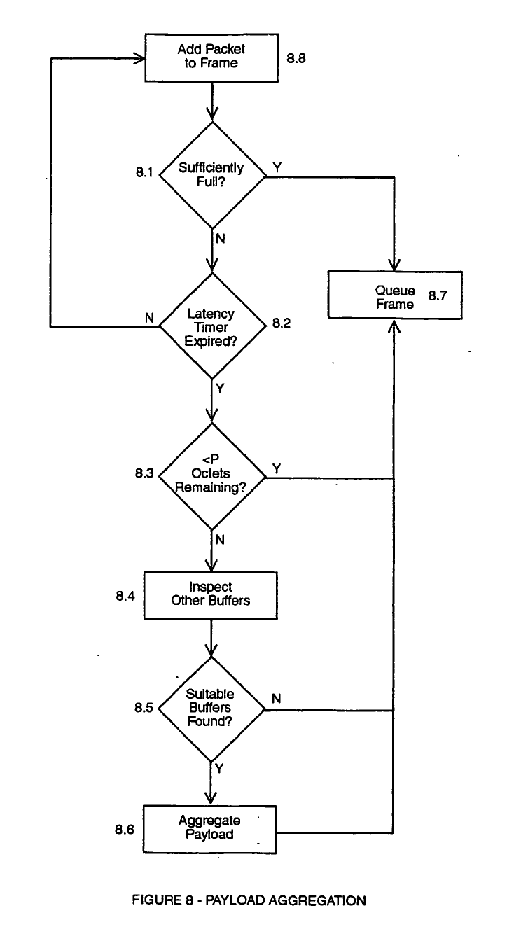

The contents of a buffer 7.9-7.12 are ready to be moved from the router 7.5 and queued for transport with the frame processor 7.6 coupled to the interfaces 7.7, 7.8 on the frame-based network when either of two conditions are satisfied. Referring to FIG. 8, the first condition 8.1 is that the frame 4.8 is sufficiently full, that is, it has less than Q octets of remaining capacity. The second condition 8.2 is that the time elapsed since the first packet (or fragment) was copied into the buffer meets or exceeds a prescribed latency requirement.

If the latency requirement has been met in step 8.2, then the remaining octet capacity of the buffer is obtained and compared at 8.3 to a software-settable parameter P. If the remaining capacity is less than P, the buffer is queued at 8.7 for transport. Otherwise, the remaining capacity of the other frame buffers is inspected at 8.4 to find (an)other buffer(s) that, when combined with the current buffer will yield a full, or nearly full, frame 4.8.

This search 8.4 for other buffers is conducted by first inspecting buffers having the same priority level (or group) as the current buffer and then searching for buffers with increasingly disparate priorities. At 8.5, when a suitable match is found, a composite frame 4.8 is constructed at 8.6 which contains the contents of the identified buffers.

The composite frame 4.8 contains packets that are destined for more than one node on the ring. Therefore, the ERP header must indicate these multiple destinations. The simplest approach is to use a network multicast or broadcast address in the ERP header. The frame 4.8 would then be read by each node and forwarded to the node's internal router for further processing. The router would parse the frame 4.8, process any packets that are destined for the attached internal networks and discard the other packets. However, this approach increases the processing overhead, since each router would need to process the entire frame 4.8. Alternatively, the frame 4.8 could be parsed by a Field Programmable Gate Array or other appropriate device (hereinafter collectively sometimes FPGA) to extract packets before sending frame 4.8 to the router. However, this approach is also inefficient because it requires the processing of the entire frame 4.8.

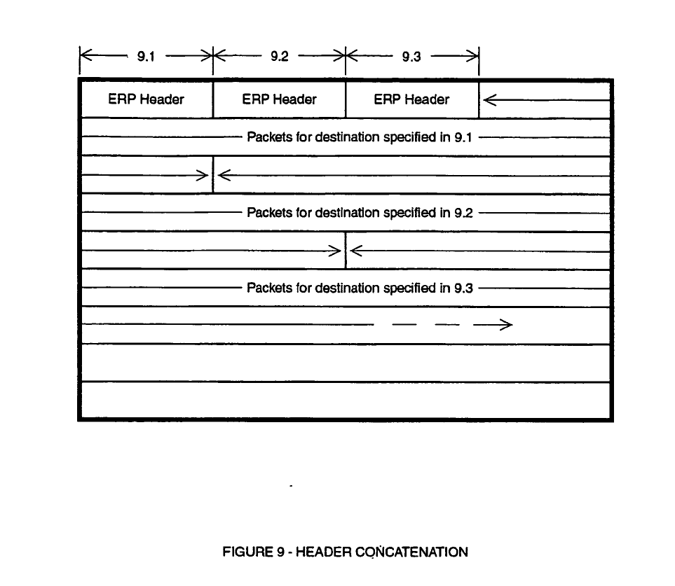

Referring to FIG. 9, the illustrated embodiment uses header concatenation when constructing the composite frames 4.8. Considering, for example, the case of three destination nodes, a frame 4.8 that contains packets for multiple destinations is constructed having an ERP header for each node that is a destination for one or more packets within the frame 4.8. At 8.5, after suitable buffers are found, an ERP header 9.1-9.3 is constructed for each of the destination nodes, and these headers 9.1-9.3 are placed at the start of the frame 4.8. The headers are followed by the packets being transported. In the illustrated embodiment, the packets are normally grouped in the same order as the headers, that is, the packets for the destination node specified by header 9.1 immediately follow the last header 9.3. These packets are followed by packets that are being sent to the node specified by header 9.2, and so on. Although the ERP header 9.1-9.3 has the PTR field 6.12, which means that the order of the groups of packets is not required to be in the same order as the ERP headers 9.1-9.3, the illustrated embodiment employs this same-order grouping.

When selecting buffers for the composite frame 4.8, the first candidate buffers selected will have the same transport priority P. If insufficient buffers are found at the same priority, the search for candidate buffers is expanded to include buffers having similar priorities. Therefore, a composite frame 4.8 may contain packets having different priorities. Nodes that forward the frame 4.8 do so based on the highest priority found among all of the ERP headers 9.1-9.3 for that frame 4.8. The search for this highest priority becomes trivial if the ERP header 9.1-9.3 having the highest priority is the first ERP header 9.1 in the frame 4.8. Alternatively, each node could treat forwarded traffic with a higher priority than traffic originating from that node.

When a composite frame 4.8 is received by a node it decrements the HL field 6.2 and sets the corresponding R bit 6.9 to one. If there is only one ERP header 9.1, or if all of the R bits 6.9 in the ERP headers 9.1-9.3 are ones, the frame 4.8 has been received by all of the destination nodes and is dropped by the last destination node. A frame 4.8 is also dropped whenever the HL field 6.2 becomes zero. If the frame 4.8 is dropped, the node may send a frame 4.8 from its frame buffers 7.9-7.12 to an external interface 7.7-7.8. If a node drops a frame 4.8 but does not have any frames 4.8 ready to send, it sends an “empty” frame 4.8 so that the frame 4.8's capacity can be utilized by a node further along the ring. A frame 4.8 is marked as empty by setting the DA 6.6 and SA 6.7 to zero. The use of “empty” frames 4.8 is controlled by a fairness algorithm that ensures that each node gets its allocated or fair share of the network capacity.

When a frame 4.8 is received by an external interface 7.7-7.8, the frame processor 7.6 inspects the first ERP header 9.1-9.3. If the destination address 6.6 in this header matches the address of this interface, the frame processor 7.6 checks the NH field 6.8. If the NH field does not indicate a concatenated header, indicating that it is not a composite frame 4.8, the offset pointer 6.12 can be used to locate the start of the data packets and these packets are sent to the router 7.5.

If the frame 4.8 includes multiple ERP headers 9.1-9.3, the frame processor 7.6 checks each ERP header 9.1-9.3 for a matching destination address. When a matching address is found, the frame processor 7.6 uses the offset pointer 6.12 to locate the starting location of packets that are destined for this node. If the matching ERP header 9.1-9.3 is not the last ERP header 9.3, then the frame processor 7.6 uses the offset pointer 6.12 of the next ERP header 9.1-9.3 to locate the end of the packets that are destined for this node. These offset pointers 6.12 permit the frame processor 7.6 to extract the group of packets for this node without inspecting other groups of packets. This pre-processing of the frames 4.8 by the frame processor 7.6 reduces the amount of data forwarded to the router 7.5, thereby reducing both the processing load on the router 7.5 and the required bandwidth for data transfers from the external interfaces 7.7-7.8 to the router 7.5. Once the packets have been extracted by the frame processor 7.6, the packets are sent to the router 7.5.

If none of the destination addresses 6.6 in the ERP headers 9.1-9.3 match the address of this interface, the HL field 6.2 is decremented and, if HL has not reached zero, the frame 4.8 is queued to an interface on the frame-based network to be transported to the next node.

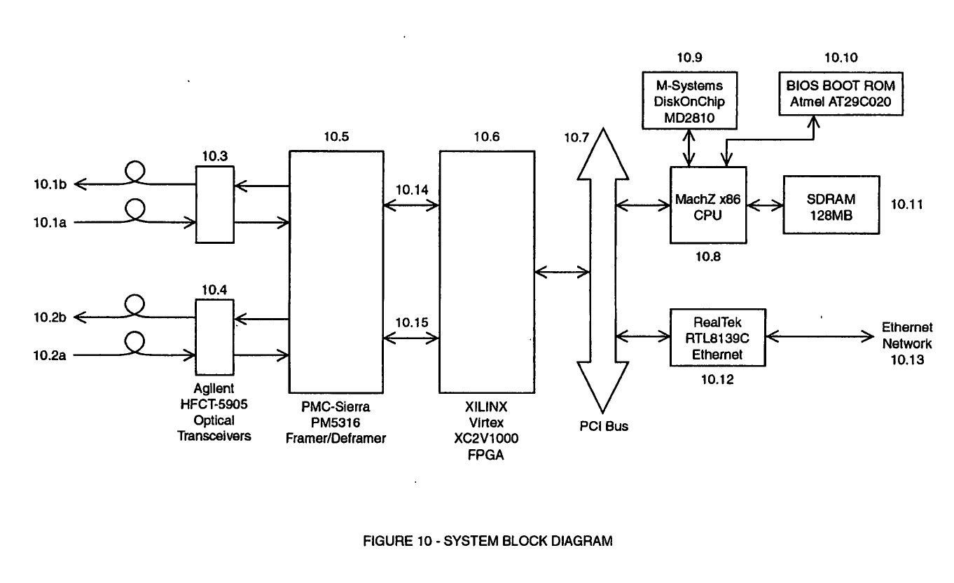

FIG. 10 illustrates a block diagram of an embodiment of the invention designed for use in a SONET OC-3 BLSR. There are two bidirectional connections 10.1-10.2 to the SONET ring. One connection 10.1 is to the inner ring and the other connection 10.2 is to the outer ring. The BLSR supports concurrent traffic in both rings. Two optical transceivers 10.3-10.4, which may be, for example, Agilent HFCT-5905 optical transceivers, convert incoming photonic signals from the SONET ring into electrical signals which serve as inputs to a SONET framer/deframer such as, for example, a PMC-Sierra PM5316 SONET framer/deframer. The transceivers 10.3-10.4 also convert outgoing electrical signals from the framer/deframer 10.5 into photonic signals 10.1b, 10.2b.

When a SONET frame is received, the framer/deframer 10.5 aligns the data stream and determines the SONET frame boundaries. The framer/deframer extracts the section, line, and path overhead bytes which are transferred over conductors 10.14 and used as inputs to an FPGA 10.6, which may be, for example, a Xilinx XC2V1000 FPGA. The SPE is also extracted from the SONET frame and is transferred over a bus 10.15 to the FPGA 10.6. The FPGA 10.6 implements the frame processor and handles the queuing of output frames 4.8. It also implements utility functions such as the CRC computation and the payload scrambler/descrambler. The payload scrambler polynomial in the current embodiment is the standard x⁴³+1.

The FPGA 10.6 contains an interface to a 32-bit Peripheral Component Interconnect (PCI) bus 10.7 which serves as the system bus. The router 7.5 is also connected to the PCI bus 10.7. In this embodiment, the router 7.5 is implemented using a high-integration CPU 10.8, such as, for example, a ZF Micro Devices MachZ x86 system-on-a-chip. One or more Ethernet devices 10.12, such as, for example, Realtek RTL8139C Ethernet devices, are also coupled to the PCI bus 10.7. Each Ethernet device 10.12 provides an interface to an external network 10.13. The external network 10.13 can serve as a source or a destination for the packet data.

When the FPGA 10.6 receives frames 4.8 containing packets that are destined for the node, that is, those having a matching DA 6.6, multicast address, or broadcast address, it extracts the packets and transfers them to the router 7.5. The transfer mechanism is direct memory access over the PCI bus 10.7 to the router memory 10.11. An interrupt is then sent to the router 7.5. The router 7.5 processes the packets using known IP routing algorithms.

If the frame 4.8 is not stripped by the node, then the FPGA 10.6 buffers the frame 4.8 and queues it for transport on another interface on the ring. If the frame 4.8 is stripped by the node or marked as empty, then the FPGA 10.6 may send a frame 4.8 that has previously been queued for transport. The source of this queued frame 4.8 is normally the router 7.5. If there are no frames 4.8 to send, the frame 4.8 is marked as empty by setting the DA 6.6 and the SA 6.7 to zero so that the frame 4.8 can be used by another node.

The router 7.5 requires the CPU 10.8 plus additional components including a non-volatile program and data store 10.9, such as, for example, an M-Systems MD2810 DiskOnChip, a boot ROM, such as, for example, an Atmel AT29C020 ROM 10.10, and a RAM, such as, for example, a 128 megabyte SDRAM 10.11.

When the invention is used for the transport of IP traffic, the inner and outer rings can be treated as network interconnections on different subnetworks by the routing software. However, since the illustrated embodiment contemplates the use of SONET protection switching, which affects the network topology, signals from the SONET APS (which are generated by the framer/deframer 10.5) are processed by the FPGA 10.6 and sent to the router 7.5 so that it can update its routing tables accordingly.

Additionally, when using typical routing software, for example, software developed for Ethernet networks, all nodes on the same BLSR appear to be on the same two subnetworks. Therefore, other nodes on a subnetwork could appear to be only one hop away even though the frames 4.8 may pass through several other nodes. To improve performance, the router 7.5 can be made aware of the actual hop count and ring topology when sending frames 4.8 to other nodes. This is facilitated by having the nodes send out topology discovery packets on a regular basis. As each topology packet passes through a node, the node appends its MAC address, ring ID, and status. When the topology packet returns to the originating node, the originating node uses this information to construct accurate routing metrics. This is a novel use of topology packets to provide and update the hop count for the interfaces on a frame-based network.

The invention combines the functionality of a router 7.5 and an ADM, but it could be implemented using a separate router.

The invention has been presented in the context of a SONET BLSR. However, it is applicable to any network having a physical or virtual ring topology. It can also be used for linear or mesh topologies. It can also be used in systems where the network capacity is allocated or channelized using any of, or any combination of, time-division multiplexing, frequency-division multiplexing, wavelength-division multiplexing, code-division multiplexing, or space-division multiplexing. The invention is independent of the network protocol of the packets being transported and that the only requirement for applicability is the need to transport a plurality of packets within a sequence of one or more frames 4.8. It is also independent of the technology of the physical layer of the network.

1. A method for transporting data packets through a data transport network including multiple interconnected circuits, the method including aggregating data packets into frames, each frame including a first field which indicates the destination address of the frame.

2. The method of claim 1 further including inspecting the first field when the frame is received at a node, and, if the first field contains an address served by the node, extracting the packets destined for the address served by the node, and forwarding to the next node frames not destined for addresses served by the node.

3. The method of claim 2 wherein aggregating data packets into frames includes aggregating data packets into frames, each containing a second field which indicates frame delivery requirements.

4. The method of claim 3 wherein aggregating data packets into frames, each containing a second field which indicates frame delivery requirements includes aggregating data packets into frames, each containing a second field which indicates a priority for queueing of frames for transport.

5. The method of claim 4 further including using the content of the second field to verify a packet transport level of service agreement between a network proprietor and a subscriber to that level of service.

6. A method for transporting data packets through a data transport network including multiple interconnected circuits, the method including aggregating data packets into frames, each frame including a field which indicates to a node on the network whether the node is to forward a packet without first inspecting it.

7. A method for transporting data packets through a data transport network including multiple interconnected circuits, the method including aggregating data packets into frames, at least one frame including a fragment containing less than all of the packet addressed to a destination address.

8. A method for multicasting data packets in a data transport network including multiple interconnected circuits, the method including providing the data packets to be multicast with the destination addresses which are to receive the multicast data packets.

9. The method of claim 8 wherein providing the data packets to be multicast with the destination addresses which are to receive the multicast data packets includes providing the data packets with multiple headers, each of the multiple headers having one of the destination addresses.

10. The method of claim 9 further including aggregating the data packets into frames, and providing the data packets with multiple headers, each having one of the destination addresses including providing in each of the multiple headers a field which contains a value which indicates the distance from a boundary within the frame to the data associated with that header.

11. Apparatus for transporting data packets through a data transport network including multiple interconnected circuits, the apparatus including a first device for aggregating data packets into frames, each frame including a first field which indicates the destination address of the frame.

12. The apparatus of claim 11 further including a second device for inspecting the first field when the frame is received at a node and extracting the packets destined for the address served by the node if the first field contains an address served by the node and forwarding to the next node frames not destined for addresses served by the node.

13. The apparatus of claim 12 wherein the first device includes a first device for aggregating data packets into frames, each containing a second field which indicates frame delivery requirements.

14. The apparatus of claim 13 wherein the first device further includes a first device for aggregating data packets into frames, each containing a second field which indicates a priority for queueing of frames for transport.

15. The apparatus of claim 14 wherein the first device for aggregating data packets into frames, each containing a second field which indicates a priority for queueing of frames for transport further includes a first device for using the content of the second field to verify a packet transport level of service agreement between a network proprietor and a subscriber to that level of service.

16. Apparatus for transporting data packets through a data transport network including multiple interconnected circuits, the apparatus including a first device for aggregating data packets into frames, each frame including a field which indicates to a node on the network whether the node is to forward a packet without first inspecting it.

17. Apparatus for transporting data packets through a data transport network including multiple interconnected circuits, the apparatus including a device for aggregating data packets into frames, at least one frame including a fragment containing less than all of the packet addressed to a destination address.

18. Apparatus for multicasting data packets in a data transport network including multiple interconnected circuits, the apparatus including a first device for aggregating the data packets to be multicast with destination addresses which are to receive the multicast data packets.

19. The apparatus of claim 18 wherein the first device includes a first device for providing the data packets with multiple headers, each of the multiple headers having one of the destination addresses.

20. The apparatus of claim 19 wherein the first device further includes a first device for providing in each of the multiple headers a field which contains a value which indicates the distance from a boundary within the frame to the data associated with that header.

21. A method for transporting data packets through a frame-based data transport network including multiple interconnected circuits, the method including aggregating data packets into frames, providing a device for identifying frames containing packets destined for addresses served by the device, and routing the identified packets to the addresses served by the device.

22. Apparatus for transporting data packets through a frame-based data transport network including multiple interconnected circuits, the apparatus including a device for identifying frames containing packets destined for addresses served by the device and routing the identified packets to the addresses served by the device.

23. A method for transporting data packets through a data transport network including multiple interconnected circuits, the method including aggregating data packets into frames, at least some of the frames being partitioned into subframes, each subframe containing one or more destination addresses and packet data intended for those one or more destination addresses.

24. Apparatus for transporting data packets through a data transport network including multiple interconnected circuits, the apparatus including a first device for aggregating data packets into frames, at least some of the frames being partitioned into subframes, each subframe containing one or more destination addresses and packet data intended for those one or more destination addresses.
